(19) United States
(12) Patent Application Publication
(10) Pub. No.: US 2004/0056230 A1
(43) Pub. Date: Mar. 25, 2004

(54) Cartridge-type especially electromagnetically directly actuated directional seat valve

(76) Inventor: Horst Rott, Karlstadt (DE)

Correspondence Address: Martin A Farber, Suite 473, 866 United Nations Plaza, New York, NY, 10017, US

(21) Appl. No.: 10/467,908

(22) PCT Filed: Jan. 24, 2002
(86) PCT No.: PCT/EP02/00680

(30) Foreign Application Priority Data
Feb. 16, 2001 (DE) 101 06 429.2

(51) Int. Cl. F16K 39/00

(52) U.S. Cl. 251/282

(57) ABSTRACT

A directional control valve which is operated directly, particularly electromagnetically, of the cartridge type. A valve of this type has a valve sleeve on the outside of which at least two connecting areas are different from one another and which has an axially running valve bore which is open towards an end face which is at the rear in the installation direction of the cartridge and towards an electromagnet, and into which a bush-like valve seat having a seating edge is inserted, and into which a transverse bore, which is open on the outside towards a connecting area opens at a distance from the seating edge. A pressure-equalizing valve piston which is located in the valve bore and integrally, has a piston cone, which can be placed on the seating edge, has a piston neck which is located in the area of the mouth of the transverse bore adjacent to the piston cone on the side of the seating edge and along which piston neck a flow cross section exists between the seating edge and the transverse bore, and, adjacent to the piston neck, has a sealing section which rests on the wall of the valve bore, forming a seal. In further development of a 2/2 or 3/2 directional control valve of the above-mentioned type so as to have a physically very small construction, the valve seat and the valve piston are arranged such that, of the piston sections, the sealing section is located closest to that end face of the valve sleeve which is at the front in the installation direction. In such arrangement, the valve sleeve holds the valve seat and the piston cone of the valve piston in an area in which it has a relatively large diameter, so that the valve seat or seats can be inserted problem-free.

The invention relates to a directional control valve which is operated directly, in particular electromagnetically, is in the form of a valve cartridge and has the features from the preamble of patent claim 1.

Directional control valves of this type are known from practice and from prospectus material from various companies. By way of example, a 3/2 directional control valve of this generic type is described on page 73 of the product information publication “Herion-information 1/87 Hydraulics”, produced by the Herion company. In this control valve, the valve piston is arranged in a valve bore which passes through the valve sleeve such that its piston cone is furthest away from the electromagnet with which the valve sleeve is assembled. Towards the electromagnet, the piston cone is followed by a piston neck along which there is a flow cross section between a seating edge and two or more transverse bores which open into the valve bore. Adjacent to the piston neck is a sealing section which seals the fluid area around the mouth of the transverse bores from the area in front of the mouth of the valve bore on the magnet side. This fluid area is connected via an axial bore, which passes through the valve piston, to a connecting area in front of that front end face of the valve sleeve which faces away from the electromagnet. The same pressure, but in opposite directions, is therefore applied to surface areas of the same size on the valve piston, whose sealing cross section is equal to the seating cross section in the area of the sealing section, thus providing pressure equalization.

The product information publication shows a simplified longitudinal section through the control valves. In the case of the 3/2 directional control valve, the piston cone (whose diameter is larger than the seating diameter) of the valve piston is located between two seating edges which are formed directly on the valve sleeve. The valve piston cannot, of course, be installed in this way. In fact, at least that seating edge which is closer to the front end face of the valve sleeve must be formed on a bush which is inserted into the valve sleeve and is referred to as the valve seat.

In the case of a 2/2 directional control valve having a valve piston which has a piston cone, a piston neck and a sealing section, it is not absolutely necessary, by virtue of the nature of the assembly process, for the seating edge to be located on a separate valve seat, which is inserted into the valve sleeve. In principle, the valve sleeve may also itself have a seating edge. However, this then has the disadvantage that, during assembly, the seal on the sealing section must be pushed over the seating edge. Another disadvantage is that the material for the valve sleeve and the material for the valve seat cannot be chosen and handled optimally in accordance with the various requirements. Overall, it therefore appears to be advantageous for a separate valve seat to be inserted into the valve sleeve, even in the case of a 2/2 directional control valve.

Particularly in the case of directional control valves of this generic type which have small nominal sizes, it is difficult to fit a valve seat into the valve sleeve close to the front end face. The external diameter of the valve sleeve normally decreases in two or more steps from the rear end face to the front end face, so that the valve seat actually has its smallest diameter in the area of the valve sleeve.

The invention is based on the object of further developing a 2/2 or 3/2 directional control valve having the features from the preamble of patent claim 1 such that it can be designed to be physically very small.

The desired aim is achieved according to the invention in that, in a corresponding way to the characterizing part of patent claim 1, the valve seat and the valve piston are arranged such that, of the piston sections, the sealing section is located closest to that end face of the valve sleeve which is at the front in the installation direction. In an arrangement such as this, the valve sleeve holds the valve seat and the piston cone of the valve piston in an area in which it has a relatively large diameter, so that the valve seat or seats can be inserted into the valve sleeve from the rear end face without any problems.

Advantageous refinements of a directional control valve according to the invention and which is operated directly can be found in the dependent claims.

If the valve is a 2/2 directional control valve, then it is sufficient for the valve piston to have only one piston neck, which is located in the valve bore, between the piston cone and the sealing section. In the case of a 3/2 directional control valve, the valve piston preferably has a piston cone which is located between two seating edges that are at a distance from one another, and has a piston neck on both sides of the piston cone.

The sealing section of the valve piston also has a guidance function in the known valves of this generic type. This guidance function is preferably also retained in a valve according to the invention. In the known valves, the sealing and guidance section, which can absorb transverse forces that are exerted by the operating element on the valve piston and can keep them away from the piston cone, is located between the point, at which the operating element acts on the valve piston, and the piston cone. In a valve according to the invention, the sealing section, seen from the point at which the operating element acts on the valve piston, is located beyond the piston cone and a piston neck. As claimed in patent claim 3, the valve piston of a valve according to the invention is now advantageously guided within a piston neck and hence close to the piston cone, so that the piston cone is in each case seated very exactly on the valve seat despite the transverse forces that are exerted. If the valve piston has a piston neck which is located alongside the piston cone towards the rear end face of the valve sleeve, then it is preferable, as claimed in patent claim 4, for the valve piston to be guided in this piston neck, that is to say between the piston cone and the point at which the operating element acts.

The guidance within a piston neck is advantageously provided as claimed in patent claims 5 and 6.

In the case of physically small valves, the radial dimensions of the valve piston, in particular, are very small. The valve piston has a very particularly small diameter in a groove in the sealing and guidance section, and this groove holds a sealing ring and one or two supporting rings. A small valve piston such as this can be drilled through axially only with difficulty. Therefore, as is claimed in patent claim 7, a fluid connection is preferably produced from a connecting area of the valve in front of the front end face of the valve sleeve through the valve sleeve to both end faces of the valve piston, for pressure equalization on the valve piston. This is feasible, in particular, because the area of the valve sleeve with a small diameter is, according to the invention, free of any inserted valve seat, so that there is still sufficient material thickness for drilling even in the area of the valve sleeve that has been mentioned. The fluid connection can advantageously be produced as claimed in patent claim 8.

The drawings illustrate a number of exemplary embodiments, which are each operated electromagnetically, of a directional control valve according to the invention. The invention will now be explained in more detail with reference to the figures in these drawings, in which:

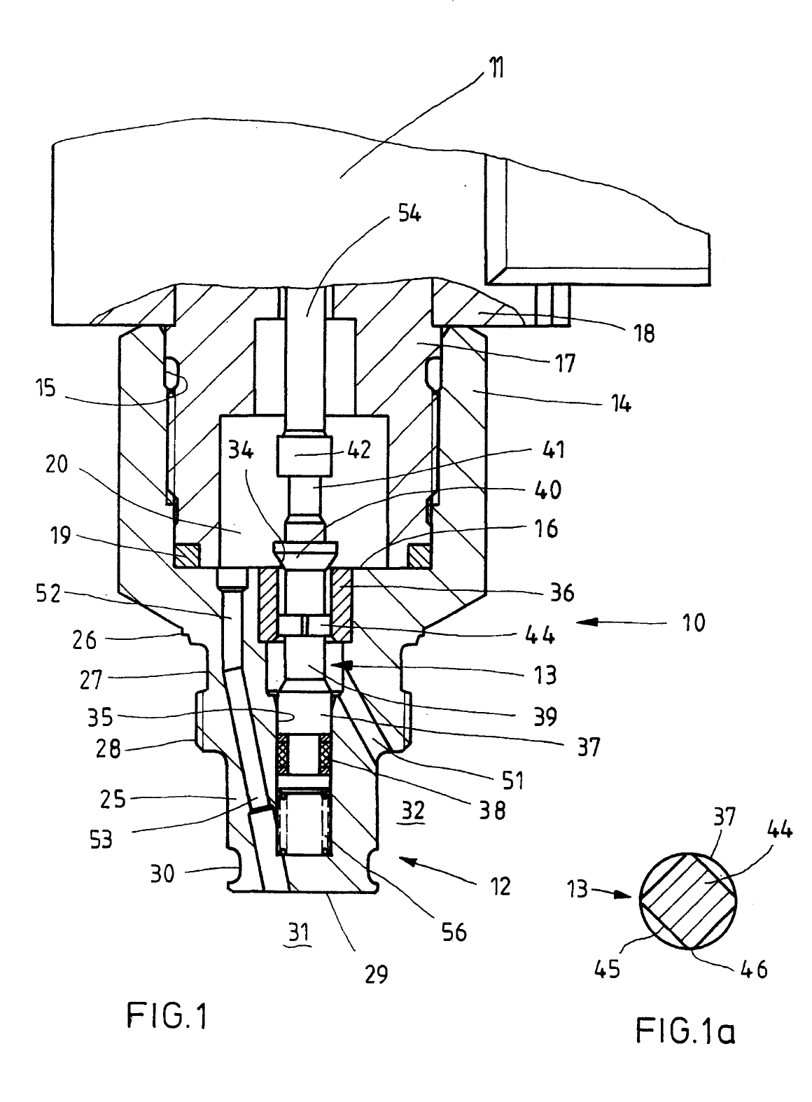

FIG. 1 shows a first exemplary embodiment, illustrating a 2/2 directional control valve which is open when no current is flowing and has a pushing electromagnet,

FIG. 1a shows a cross section through the valve piston of the first exemplary embodiment,

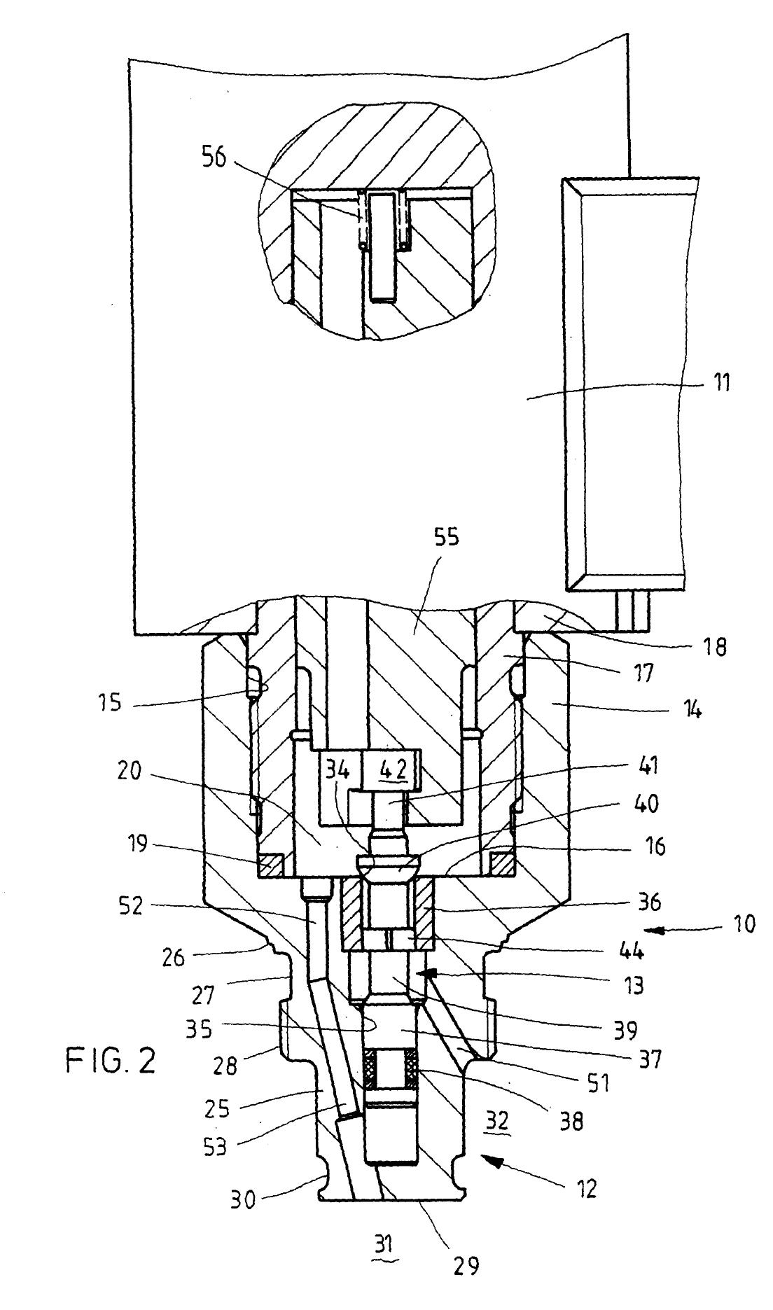

FIG. 2 shows a second exemplary embodiment, which illustrates a 2/2 directional control valve which is closed when the current is flowing and has a pulling electromagnet,

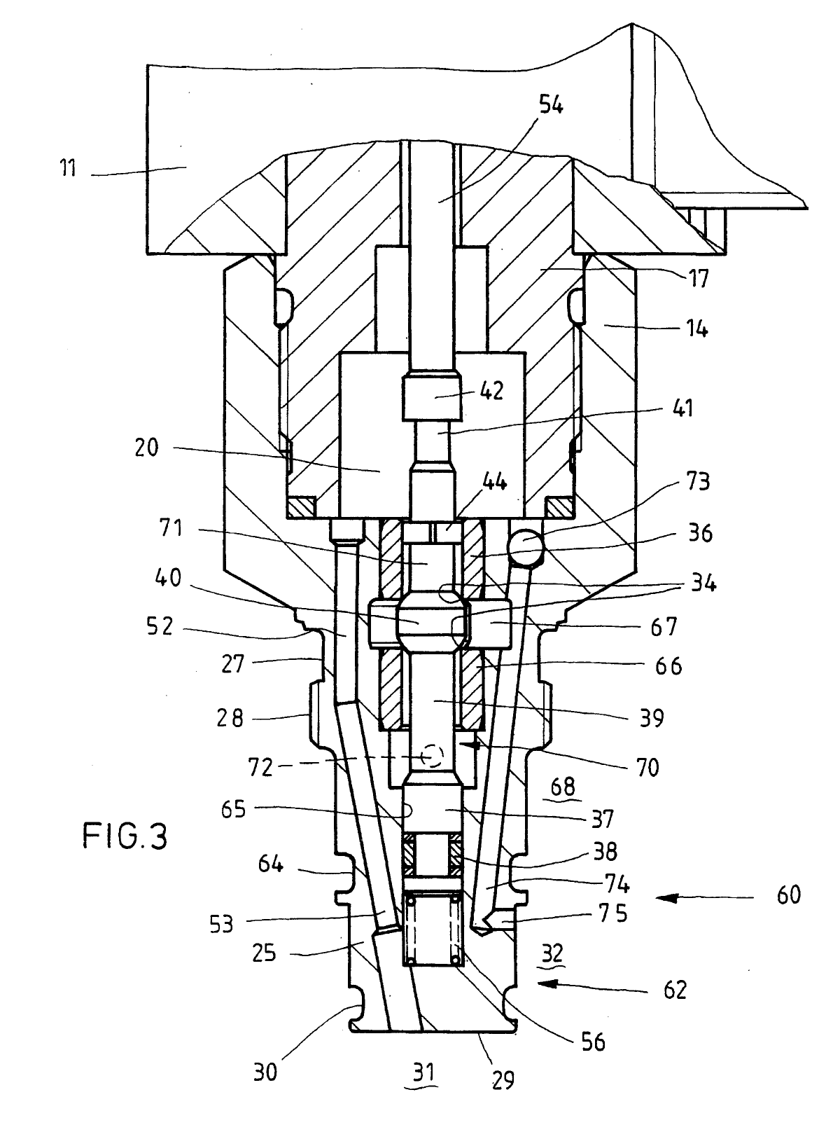

FIG. 3 shows a third exemplary embodiment, illustrating a 3/2 directional control valve with a pushing electromagnet, and

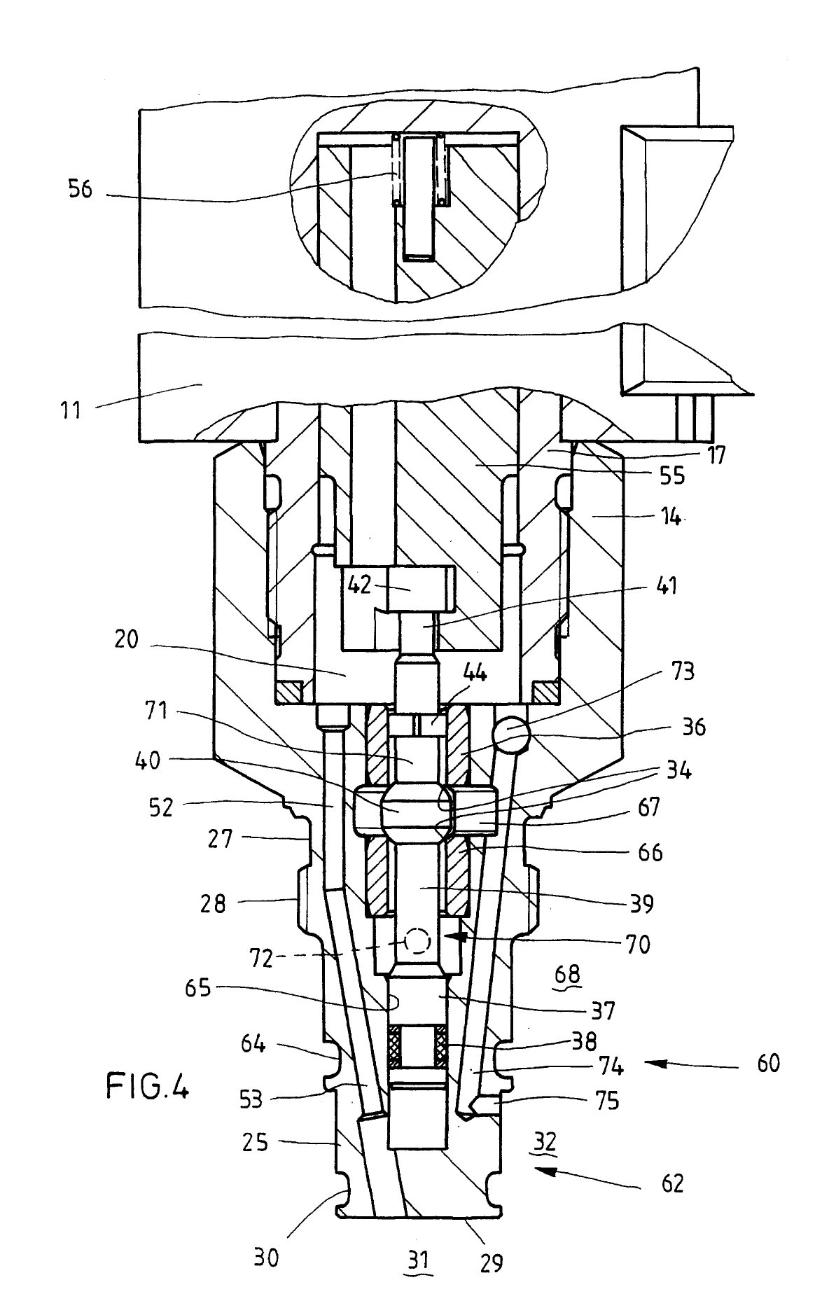

FIG. 4 shows a fourth exemplary embodiment, illustrating a 3/2 directional control valve with a pulling electromagnet.

The 2/2 directional control valves shown in FIGS. 1 and 2 are composed of a hydraulic part 10 and an electromagnet 11, and are in the form of screw-in cartridges. The hydraulic part 10 essentially comprises a valve sleeve 12 and a moving valve piston 13. The electromagnet 11 and the valve sleeve 12 are screwed to one another. For this purpose, the valve sleeve 12 has a holding part 14, which has a large external diameter and is provided with an internal thread over a certain distance in a large holder 15, which is like a blind hole, with a base 16. The electromagnet 11 has a pole tube 17 and a coil 18 which is pushed over the pole tube. The pole tube is screwed into the holder 15 of the valve sleeve 12 as far as the base 16. A seal 19 is located in front of the threads (which engage in one another) of the pole tube and valve sleeve, and between these two parts, which seal 19 provides an external seal, against leakage via the thread, for a fluid area 20 which is bound on one side by the base 16 of the holder 15 and on the other side by the walls of a cutout, which is open towards the base, in the pole tube 17. The base 16 can be regarded as a rear end face of the valve sleeve, which faces the electromagnet 11 and is at right angles to the axis of the valve sleeve.

In front of the holding part 14, the valve sleeve 12 has a control part 25 whose radial dimensions are significantly smaller than the external diameter of the holding part. Only the control part 25 is held by the corresponding holding bore after installation of a valve in a housing part. The valve sleeve merges conically from the holding part 14 into the control part 25. There is a small step 26 just in the corner between the control part and the conical surface, and this comes to rest on a housing part when the cartridge is installed in that housing part.

An annular groove 27 for a seal that is not illustrated is turned externally into the control part 25 at a short distance from the step 26, and this seal provides an external seal for the holding bore for the installed cartridge. The annular groove is followed by an external thread 28, which is used for screwing the cartridge into a housing part. After the external thread, the control part 25 continues with an external diameter that is reduced even further as far as a front end face 29, which projects at right angles to the sleeve axis. A seal can be held in an annular groove 30 shortly behind the end face. Once the cartridge has been installed, this seal subdivides the area surrounding the valve sleeve into an axial connecting area 31, which is located essentially in front of the end face 29 and thus axially in front of the valve sleeve, and a radial connecting area 32 which is located radially outside the valve sleeve.

The valve sleeve 12 has a valve bore 35 which runs on the axis and opens into the fluid area 20, while it is closed towards the end face 29. From its base approximately as far as the transition between the annular groove 27 and the external thread 28, the valve bore 35 has a first diameter in a first section, then merges into a widened area as a second section, in order finally to return to the first diameter over a certain distance in a third section, and thus to open into the fluid area 20. This last section of the valve bore 35 is formed by a bush-like valve seat 36, which is pressed into the valve sleeve 12 from the end face 16. The end-face inner edge of the valve seat 36 forms the only seating edge 34 of the valve that is fixed to the housing.

The valve piston 13 is held in the valve bore 35 such that it can move axially and is essentially located with a sealing and guidance section 37, whose diameter is equal to the first diameter of the valve bore 35, in its first section and, in a groove in it, has a seal 38 which forms a seal between the second, widened section of the valve bore and the area between the valve piston and the base of the valve bore. The section 37 is followed by a piston neck 39, in which the diameter of the valve piston 13 is smaller than the first diameter of valve bore, and by means of which the valve piston passes through the widened section of the valve bore and through the valve seat 36. In front of the seating edge 34, the piston neck is followed by a piston cone 40, whose diameter is larger than the first diameter of the valve bore and by means of which the valve piston 13 can be seated on the seating edge 34. The piston cone is followed by a connecting section 41, which is located in the fluid area 20 and ends in a plate 42.

Approximately in the center of the piston neck 39 and within the bush-like valve seat 36, the valve piston 13 has a short guide collar 44, which is provided with two or more flats 45 which are distributed uniformly over the circumference, and between which circular-cylindrical area elements 46 remain, which rest internally on the valve seat 36, so that, on the one hand, the valve piston is guided close to the piston cone 40 while, on the other hand, it is also possible for fluid to flow through the valve seat.

An oblique bore 51, which runs through the valve sleeve 12, is open on the outside to the radial connecting area 32 and thus for fluid-flow purposes connects this connecting area to the area of the valve bore 35 located between the sealing section 37 of the valve piston 13 and the seating edge 37, opens into the widened section of the valve bore 35 in front of one face of the valve seat 36. The fluid area 20 is connected for through-flow purposes to the axial connecting area 31 via an axial bore 52 which originates from the end face 16 of the valve sleeve 12, and via an oblique bore 53 which originates from the end face 29 and meets this axial bore 52. The oblique bore 53 intersects the valve bore 35 between its base and the sealing section 37 of the valve piston 13. Both end faces of the valve piston are thus subject to the same pressure, that is to say the pressure in the axial connecting area. Since, furthermore, the diameter of the sealing section 37 is equal to the diameter of the seating edge 34, the valve piston is subjected to a pressure-equalization force, that is to say it is not subjected to any force resulting from any of the pressures that are applied.

To the extent described so far, the two exemplary embodiments as shown in FIGS. 1 and 2 are completely identical to one another. The first difference is that, in the exemplary embodiment shown in FIG. 1, what is referred to as a pushing electromagnet is used, whose magnet armature (which is not shown in any more detail) moves in the direction of the end face 16 of the valve sleeve 12 when current flows through the magnet coil, while, in the exemplary embodiment shown in FIG. 2, what is referred to as a pulling electromagnet is used, whose magnet armature 55 moves in the direction away from the end face 16 of the valve sleeve 12 when current flows through the magnet coil. A plunger 54 is mounted on the magnet armature of the pushing electromagnet shown in FIG. 1, and the plate 42 of the valve piston 13 rests on this plunger 54. To be precise, the valve piston is held on the plunger by a helical compression spring 56, which is clamped in between the valve piston 13 and the base of the valve bore 35 and exerts a force on the valve piston in the sense of lifting the piston cone 40 off the seating edge 34. In contrast to the exemplary embodiment shown in FIG. 1, in the exemplary embodiment shown in FIG. 2, the valve piston 13 is hooked by the plate 42 like a bayonet into a cutout in the magnet armature of the pulling electromagnet with a small amount of play in the axial direction. Furthermore, in contrast to the exemplary embodiment shown in FIG. 1, a helical compression spring 56 is arranged within the electromagnet, rather than in the valve bore, in the exemplary embodiment shown in FIG. 2. This helical compression spring loads the magnet armature and hence the valve piston 13 in the sense of the piston cone 40 being seated on the seating edge 34 of the valve seat 36.

When no voltage is applied to the coil of the electromagnet in the exemplary embodiment shown in FIG. 1, the compression spring 56 raises the valve piston off the seating edge 34 on the valve seat 36. Hydraulic fluid can flow both from the axial connecting area 31 via the bores 53 and 52, via the fluid area 20, via a circumferential through-flow cross section between the seating edge 34 and the piston cone 40, along the piston neck 39 and via the bore 51 to the radial connecting area 32 and via the same path from the radial connecting area 32 to the axial connecting area 31.

When voltage is applied to the electromagnet 11, then the magnet armature moves the valve piston 13 against the compression spring 56 until the piston cone 40 is seated on the seating edge 34. The fluid connection between the two connecting areas is then blocked in both flow directions.

The valve shown in FIG. 1 is thus an electromagnetically operable 2/2 directional control valve which is open when no current is flowing.

When no voltage is applied to the coil of the electromagnet in the exemplary embodiment shown in FIG. 2, the compression spring 56 presses the piston cone 40 of the valve piston 13 against the seating edge 34 via the magnet armature 55, so that it is impossible for any hydraulic fluid to flow between the two connecting areas 31 and 32. When voltage is applied to the electromagnet 11, then the magnet armature lifts the valve piston 13 off the seating edge 34 against the force of the compression spring 56. Hydraulic fluid can then flow in both directions between the two connecting areas.

The valve shown in FIG. 2 is thus an electromagnetically operable 2/2 directional control valve which is closed when no current is flowing.

The 3/2 directional control valve shown in FIG. 3 uses the same pushing electromagnet 11 as that for the 2/2 directional control valve shown in FIG. 1, and the 3/2 directional control valve shown in FIG. 4 uses the same pulling magnet 11 as that for the 2/2 directional control valve shown in FIG. 2. The two valves shown in FIGS. 3 and 4 differ only in the configuration of the hydraulic part of the valves shown in FIGS. 1 and 2. The hydraulic parts 60 of the two valves shown in FIGS. 3 and 4 when compared with one another differ only in the arrangement of a helical compression spring 56.

The valve sleeve 62 of a valve shown in FIGS. 3 and 4 has the same holding part 14 as a valve sleeve 12 shown in FIG. 1 or 2. The control part 63 of the valve sleeve 62, on the other hand, is longer than that of a valve sleeve 12. To be precise, a further section is inserted axially between the section with the annular groove 27 for a seal and with the external thread 28 and the section with the annular groove 30 for a seal, and the size of the external diameter of this further section is between the external diameters of the two other sections, and it has an annular groove 64 for a further seal. The further seal provides a further radial connecting area 88, between the seal that is located in the annular groove 64 and the external thread 28 as well as the seal in the annular groove 27, radially outside the valve sleeve, alongside the radial connecting area 32 between the seals which are located in the annular grooves 30 and 64.

The valve sleeve 62 has a valve bore 65 which runs on the axis and opens into the fluid area 20, which is once again bounded by the rear end face 16 of the valve sleeve and the pole tube 17, while it is closed towards the front end face 29. In a first section from its base as far as the additional section of the control part 25, the valve bore 65 has a first diameter, then merges into a centric widened area as a second section, is then in a following section, which once again has the first diameter, is formed by a first bush-like valve seat 66, which is inserted into the valve sleeve 62, and then has an eccentric widened area 67 in order finally to have the first diameter once again over a certain distance in a final section, and thus to open into the fluid area 20. This final section of the valve bore 65 is formed by the bush-like valve seat 36 in the same way as in the exemplary embodiments shown in FIGS. 1 and 2, which bush-like valve seat 36 is identical to the valve seat 66 and is separated from it by a distance which corresponds to the width of the widened area 67. There are therefore now two valve seats, whose inner edges are two seating edges 34 on the end faces which face one another and face the widened area 67.

A valve piston 70 is held in the valve bore 65 such that it can move axially and has a sealing and guidance section 37 whose diameter is equal to the first diameter of the connecting bore 65, is essentially located in its first section and has a seal 38 in a groove in it, which seal 38 seals the second widened section of the valve bore and the area between the valve piston and the base of the valve bore from one another. The section 37 is followed by a piston neck 39, in which the diameter of the valve piston 70 is smaller than the first diameter of the valve bore, and by means of which the valve piston passes through the concentrically widened section of the valve bore, and through the valve seat 66. In the eccentrically widened area 67, the piston neck 39 is followed by a piston cone 40, whose diameter is larger than the first diameter of the valve bore. The piston cone 40 is formed symmetrically with respect to a plane at right angles to the axis of the valve sleeve 62. The valve piston 13 is seated by this piston cone, with the exception of the switching processes, on the seating edge 34 of either the valve seat 66 or the valve seat 36. The piston cone 40 is followed by a further piston neck 71, which projects through the valve seat 36 into the fluid area 20, and the piston neck 71 is, finally, followed by the connecting section 41, which is located in the fluid area 20 and ends in a plate 42. In the exemplary embodiment shown in FIG. 3, the plunger 54 of the pushing electromagnet rests on this plate 42. In the exemplary embodiment shown in FIG. 4, the valve piston 70 is hooked by means of the plate 42 into the magnet armature 55 of the electromagnet.

In the piston neck 71 and within the bush-like valve seat 36, the valve piston 70 has a short guide collar 44, which is provided with two or more flats 45 (see FIG. 1a), which are distributed uniformly over the circumference and between which circular-cylindrical surface elements 46 remain, which rest internally on the valve seat 36 so that, on the one hand, the valve piston is guided close to the piston cone 40 while, on the other hand, it is still possible for fluid to flow through the valve seat 36. Where the valve piston 13 shown in FIGS. 1 and 2 and the valve piston 70 shown in FIGS. 3 and 4 have sections that are comparable to one another, they are provided with the same reference numbers.

A bore 72 which runs through the valve sleeve 62 opens into the concentrically widened section of the valve bore 70 in front of one face of the valve seat 66, is open on the outside to the radial connecting area 68 and thus, for fluid-flow purposes, connects this connecting area to the area of the valve bore 65 which is located between the sealing section 37 of the valve piston 70 and the seating edge 34 on the valve seat 66. The radial connecting area 32 is connected for fluid flow purposes to the widened area 67 via an oblique bore 74, which is introduced from the end surface 16 where it is closed by a pushed-in sphere 73 and which intersects the eccentric widened area 67, and via a radial bore 75 which intersects it. The fluid area 20 is connected for fluid flow purposes to the axial connecting area 31 via an axial bore 52 which originates from the end face 16 of the valve sleeve 12, and via an oblique bore 53 which originates from the end face 29 and intersects the axial bore 52. The oblique bore 53 intersects the valve bore 65 between its base and the sealing section 37 of the valve piston 70. The pressures are thus also equalized for the valve piston 70 in the valves shown in FIGS. 3 and 4.

To the extent described so far, the hydraulic parts 60 in both exemplary embodiments shown in FIGS. 3 and 4 are completely identical to one another. The difference is that, in the exemplary embodiment shown in FIG. 3, a helical compression spring 56 is clamped in between the valve piston and the base of the valve bore, while there is no such spring in the hydraulic part in the exemplary embodiment shown in FIG. 4. In fact, in this case, the helical compression spring 56 is located in the electromagnet 11, behind the magnet armature 55, and acts in the opposite direction.

In the exemplary embodiment shown in FIG. 3, the compression spring 56 pushes the valve piston 70 with the piston cone 40 against the seating edge of the valve seat 36 when no current is flowing through the electromagnet. There is a through-flow cross section between the seating edge of the valve seat 66 and the piston cone 40. Hydraulic fluid can thus flow from the radial connecting area 32 via the bores 75 and 74, the eccentric widened area 67, the through-flow cross section between the piston cone 40 and the valve seat 66, along the piston neck 39, via the concentrically widened area of the valve bore on one face of the valve seat 66, and via the bore 72 to the radial connecting area 68, and vice versa.

When voltage is applied to the electromagnet, the piston cone 40 of the valve piston 70 is pressed against the valve seat 66, against the force of the compression spring 56. Hydraulic fluid can now flow from the radial connecting area 32 via the bores 75 and 74, the eccentric widened area 67, the through-flow cross section between the piston cone 40 and the valve seat 36, along the piston neck 71, via the fluid area 20 and via the bores 52 and 53 to the axial connecting area 31, and vice versa.

In the exemplary embodiment shown in FIG. 4, the possible flows when the electromagnet 11 is switched on and off are interchanged with one another in comparison to the exemplary embodiment shown in FIG. 3. This is immediately evident.

1. A directional control valve which is operated directly, in particular electromagnetically, of the cartridge type,
having a valve sleeve (12,62) on the outside of which at least two connecting areas (31,32,68) are different to one another and which has an axially running valve bore (35,65) which is open towards an end face (16) which is at the rear in the installation direction of the cartridge and towards an operating element (11), and into which a bush-like valve seat (36,66) having a seating edge (34) is inserted, and into which a transverse bore (51,72) which is open on the outside towards a connecting area (32,68) opens at a distance from the seating edge (34),
having a pressure-equalizing valve piston (13,70) which is located in the valve bore (35,65) and which, integrally, has a piston cone (40), which can be placed on the seating edge (34), has a piston neck (39) which is located in the area of the mouth of the transverse bore (51,72) adjacent to the piston cone (40) on the side of the seating edge (34) and along which piston neck (39) a flow cross section exists between the seating edge (34) and the transverse bore (51,72), and, adjacent to the piston neck (39), has a sealing section (37) which rests on the wall of the valve bore (35,65), forming a seal,
characterized by the fact that
the valve seat (36,66) and the valve piston (13,70) are arranged such that, of the piston sections, the sealing section (37) is located closest to that end face (29) of the valve sleeve (12,62) which is at the front in the installation direction.

2. The directional control valve as claimed in claim 1, characterized by the fact that the piston cone (40) is located between two seating edges (34) which are at a distance from one another, and the valve piston (70) has a piston neck (39,71) on both sides of the piston cone (40).

3. The directional control valve as claimed in claim 1 or 2, characterized by the fact that the valve piston (13,70) is guided within a piston neck (39,71) in the valve bore (35,65).

4. The directional control valve as claimed in claim 3, characterized by the fact that the valve piston (70) is guided in the valve bore (65) within that piston neck (71) which is located alongside the piston cone (40) towards the rear end face (16) of the valve sleeve (62).

5. The directional control valve as claimed in claim 3 or 4, characterized by the fact that the valve piston (13,70) has on a piston neck (39,71) a guide collar (44) which is at a distance from the piston cone (40), has one end surface facing away from the piston cone (40) and, on its circumference, has at least one flow cutout.

6. The directional control valve as claimed in claim 5, characterized by the fact that the guide collar (44) has two or more flow cutouts which are distributed uniformly over its circumference.

7. The directional control valve as claimed in any preceding claim, characterized by the fact that one connection area (31) is located in front of the front end face (29) of the valve sleeve (12,62), and that the valve sleeve (12,62) provides an open fluid connection in front of both end faces of the valve piston (13,70).

8. The directional control valve as claimed in claim 7, characterized by the fact that the valve bore (35,65) is a blind bore which is closed towards the front end face (29) of the valve sleeve (12,62), and that the blind bore is intersected between its base and the valve piston (13,70) by a connecting bore (53) which originates from the front end face (29) of the valve sleeve (12,62), runs obliquely with respect to the axis of the valve sleeve, and forms a fluid connection to the area (20) in front of the mouth of the valve bore (35,65).
